(19) United States
(12) Patent Application Publication
(10) Pub. No.: US 2004/0110118 A1
(43) Pub. Date: Jun. 10, 2004

(54) Method and system for assessment of user performance

(76) Inventors: Harry Kennedy Clark, Vienna, VA (US); James L Boney, Severn, MD (US); Kasempath Meesuk, Glen Burnie, MD (US)

Correspondence Address: John Campa, Nixon Peabody, Clinton Square, P O Box 31051, Rochester, NY, 14603-1051, US

(21) Appl. No.: 10/415,465

(22) PCT Filed: Nov. 13, 2001
(86) PCT No.: PCT/US01/43056

(51) Int. Cl. G09B 3/00

(52) U.S. Cl. 434/350; 434/362; 434/323

(57) ABSTRACT

A method and system for assessing a user (115) regarding control of one or more devices that include comparing information regarding a configuration (105) of at least one of the devices against at least one evaluation criteria (103), comparing information regarding state information (106) for the device against at least one evaluation criteria, and assessing the user using the above comparisons.

### BACKGROUND OF THE INVENTION

The following describes systems and methods for assessing a user's proficiency regarding a device (or set of devices) by evaluating the user/student's control over the device(s). “Controlling the device(s)” includes their ability to correctly configure, troubleshoot, test, diagnose, initialize, set up, build, arrange, and analyze these devices.

Traditionally, students are assessed based on taking a test where they are asked multiple choice and/or true-false questions regarding the device or control of the device, thus testing their knowledge regarding control of the device. In an embodiment of the present invention, rather than simply asking a student questions regarding the device, the student is presented with a real world task regarding the control of the device (or set of devices). The student then exercises control over the one or more devices to perform the task. In an embodiment, the student may exercise control over one or more devices remotely over a network such as the Internet or a LAN. For example, the student may exercise control over the one or more devices using Mentor Technologies™ vLab™ system. For a more detailed description of a system for remote training on devices, see “Methods and Apparatus for Computer Based Training Relating to Devices,” of T. C.

Slattery, et al., U.S. patent application Ser. No. 09/365,243, filed Jul. 30, 1999, which is hereby incorporated by reference. After completing the task, the student is assessed on his/her performance or skills in controlling the device(s).

### SUMMARY OF THE INVENTION

Methods and systems consistent with the present invention include systems and methods for assessing a user regarding control of one or more devices that include comparing information regarding a configuration of at least one of the devices against at least one evaluation criteria, comparing information regarding state information for the device against at least one evaluation criteria, and assessing the user using the above comparisons

### BRIEF DESCRIPTION OF THE DRAWINGS

FIG. 1 illustrates an assessment system in accordance with methods and systems consistent with the invention;

FIG. 2 illustrates a screen in accordance with methods and systems consistent with the invention;

FIG. 3 illustrates an example output in accordance with methods and systems consistent with the invention;

FIG. 4 illustrates an illustration of a results for report in accordance with methods and systems consistent with the invention;

FIG. 5 illustrates an example analysis matrix report in accordance with methods and systems consistent with the invention;

FIG. 6 illustrates an example configuration report in accordance with methods and systems consistent with the invention;

FIG. 7 illustrates an example non-configuration report in accordance with methods and systems consistent with the invention;

FIG. 8 illustrates an example screen in accordance with methods and systems consistent with the invention; and

FIG. 9 illustrates an example user administration screen in accordance with methods and systems consistent with the invention.

### DESCRIPTION OF THE EMBODIMENTS

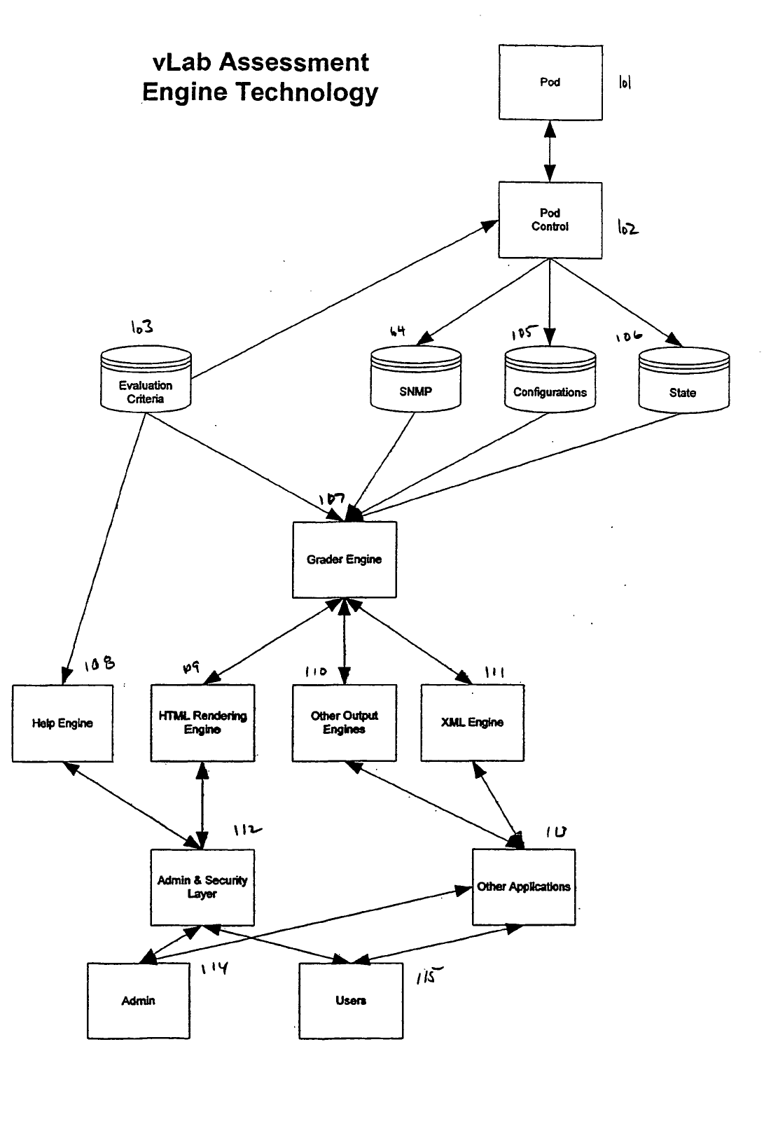

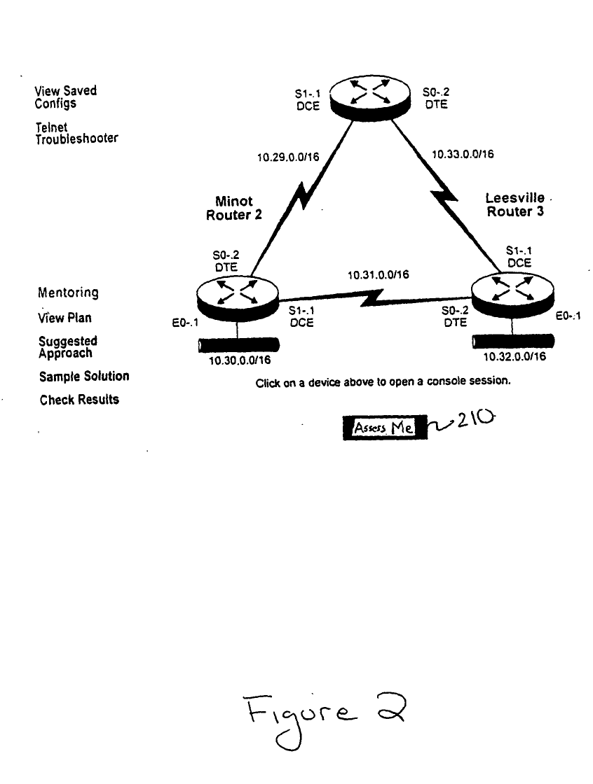

FIG. 1 provides an illustration of an assessment system, in accordance with methods and systems consistent with the invention. In an embodiment, either during an assignment or once an assignment regarding control of a pod including one or more device(s) 101 is completed, the student can request that they be assessed based on their performance of the training exercise. For example, FIG. 2 illustrates a screen that may be presented to a user performing an assignment using the vLab™ system. As shown, the user may be permitted to select an “Assess Me” button 210 to provide feedback in the middle of an assignment or exercise. By selecting this button 210, assessment may be initiated. In other embodiments, assessment may be initiated automatically upon completion of an exercise. This may occur, for example, in a classroom type setting where the assignment is performed as a test of the students' abilities. In addition, assessment may be performed in other types of systems where the student exercises actual control over devices on which they are being evaluated.

Once assessment is initiated, various types of information may be gathered and transferred to a Grader Engine 107. This information may include device configurations 105, state information 106 regarding the device(s), SNMP results 104 from the devices in the pod 101 and other devices connected to the pod's devices, and/or other information. These various types of data will be collectively referred to as “Device Information”. In addition, to device information, information is gathered regarding grading and/or Evaluation Criteria 103 (“Evaluation Criteria”).

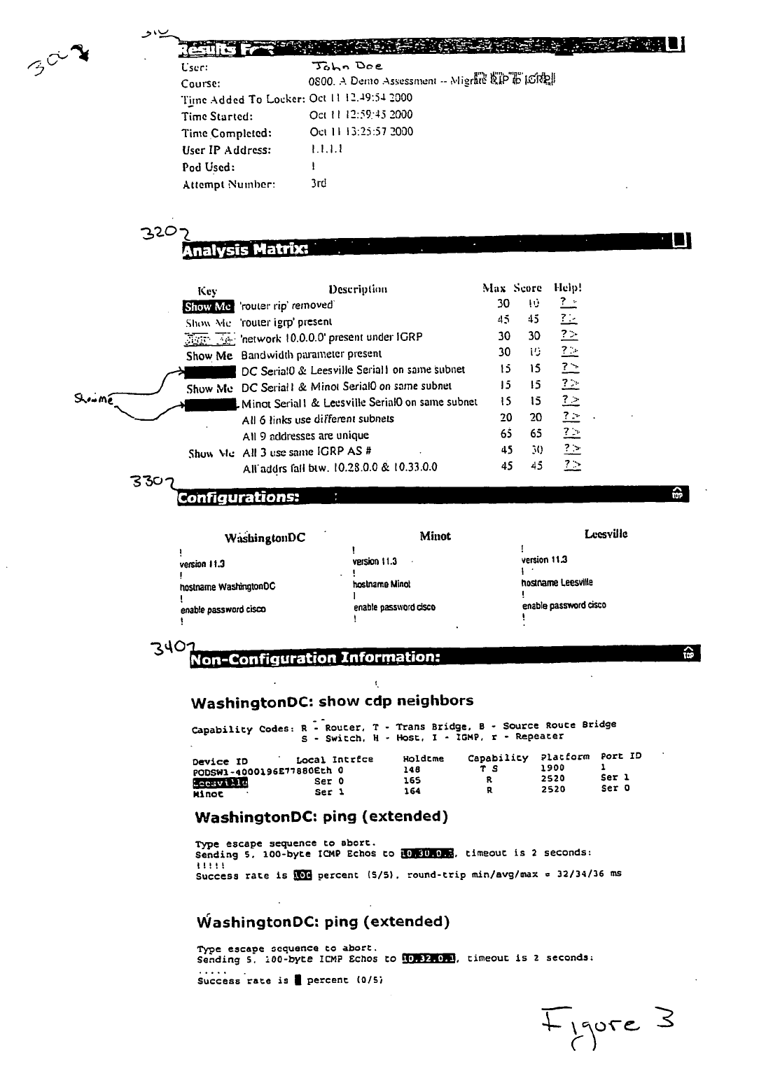

After collecting, analyzing and comparing the Device Information to the Evaluation Criteria 103, the Grader Engine 107 generates an output that may include a variety of reports with information regarding student performance. FIG. 3 illustrates an example output 300 that may be presented to a vLab™ system user. As shown, this output may include a Results For report 310, an Analysis Matrix report 320, a Configurations report 330, and a Non-Configuration Information report 340. These various reports will be discussed in more detail below. As will be obvious to one of skill in the art, this is only one example of an output that may be presented to a user, and there are numerous other types of outputs containing various reports that may be presented to the user. This will depend in part on the type of system and types of devices using the present invention, in addition to other criteria.

In evaluating student performance the Grader Engine 107 may execute a series of diagnostic commands that captures the actual state of the network to which the device is connected, thus allowing the Grader Engine 107 to analyze real-time traffic such as ping, traceroute, adjacencies, routing tables, and other diagnostic commands regarding that device and/or network. The results and diagnostics commands can be issued either during the lab for “real time” evaluation, or at the end of the lab and stored in a database for future reporting.

Further, the Grader Engine 107 may use pattern matching and parsing technology to evaluate the Device Information (104, 105, and 106) against the Evaluation Criteria 103. The pattern matching and parsing technology may be presented in a hierarchy of “functions” for purposes of authoring the assessment. These provide a range of flexibility and power. For example, there can be “general-purpose” functions where the author of the assessment specifies the raw pattern match or parser, “wrapper” functions that are easier to use but less flexible, and “canned” functions that hide the parsing details, but are specific in their use.

General-purpose functions involve the use of regular expressions, a pattern-matching language commonly used in UNIX and programming environments. Consequently, these functions are extremely flexible, but more difficult to use because they require the author to understand the regular expression language or other forms of pattern matching logic.

Wrapper functions take a regular expression and other forms of pattern matching logic supplied by the author and automatically “wrap” it inside of a larger regular expression, pattern matcher, or programming logic. Adding this “wrapper” makes the author's job considerably easier because it saves them from having to write complex expressions that only match in the desired context. For example, writing an expression that only matches an IP address on a given interface can be fairly tricky (it is easy for the IP address to inadvertently match on a different interface earlier or later in the config). The interface( ) wrapper function automatically limits the expression to the specified interface (or list of interfaces), allowing the author to concentrate on the much simpler process of matching on something inside that interface (for example, “ip address 1\.1.\1.\.1 255\.255\.0\.0” to ensure that the interface has an address of 1.1.1.1 and a /16 mask). Given that many interface (and related) matching tasks only require very basic (or no) wildcard characters, writing a criterion using a wrapper function is normally extremely simple. However, for more complex requirements, the author can always resort to the full power of regular expressions and other forms of pattern matching and parsing logic.

Canned functions are tailor-made to solve specific assessment requirements. Because they totally insulate the author from having to write complex expressions, they are extremely easy to use. However, their use is also considerably more limited than that of the “general-purpose” and “wrapper” functions. For example, the shCdpNeigh( ) function is only designed to process the output of the “show cdp neighbors” command. Although it is flexible enough to automatically determine if the command was issued with the “detail” option and automatically adjust its logic, it will never be useful for looking at other types of router information (for example, the routing tables). On the other hand, shCdpNeigh( ) is very easy to use: simply tell the function which devices you want to process CDP output from and a list consisting of: (i) a neighbor's name, (ii) the local interface used to reach the neighbor, (iii) the neighbor's interface used to reach the local router, and (iv) a list of Layer 3 protocols and addresses. This, and other, functions can allow “wildcards” to be specified by omitting various parameters.

The Evaluation Criteria 103 may be based on a set of desired learning objectives which are allocated differing amounts of grading points based on the relative importance of the specific learning objective. By comparing the Device Information (104, 105, and 106) to the Evaluation Criteria 103, the Grader Engine 107 may determine whether the student has met the relevant learning objects, award full or partial credit, deny credit altogether, and then generate an overall score.

In addition, the Grader Engine 107 may include a “land mine” feature that deducts points from as student's score when student enters certain commands into, or takes certain actions with respect to, the device, e.g., enters commands to try to circumvent the learning exercise. That is, the Grader Engine 107 may include the ability to look for certain types of actions that indicate that a student attempted to “cheat” the exercise.

Further, the Grader Engine 107 may include the capability to grant partial credit. The granting of partial credit may be made either based on pre-established criteria or new criteria established by the Grader Engine 107 based on specific Device Information (103, 104, and 105). This may be accomplished by the Grader Engine 107 using the above-described pattern matching and parsing technology, as well as by establishing a logical hierarchy between multiple criteria. This feature allows the Grader Engine 107 to assess a multitude of possible solutions a student may arrive at in trying to perform the designated tasks. Furthermore, use of pattern matching and parsing technology to permit an automated grading approach does not require that the author specifically address every possible solution to the learning exercise.

In addition, the system may include a Help Engine 108 that permits the student to link to other information related to a specific learning objective. These links may include technical notes, reference materials, and listings of classes or seminars that address that objective, among others. The Help Engine 108 is a software module that is triggered when the user selects a help link or function from one of the various types of feedback reporting produced by the Grader Engine 107 and its associated output modules. In generating the help information, the Help Engine 108 will access information in the Evaluation Criteria 103 and other possible sources such as a meta-database of remedial information and feedback.

The results generated by the Grader Engine 107 may be used to feed a variety of other outputs, such as an HTML L Rendering Engine 109, XML Engine 111, or other forms output 110, which in turn can, among other things, generate a variety of reports, including one that lists the learning objectives, number of maximum grading points allocated to each learning objective, and the actual number of points awarded to the student based on his or her performance. The HTML Engine 109 is a software process that generates information to be sent to a web browser via a network such as the Internet. The XML and other output engines are similar software processes, but they can output the results of the assessment information in a wide variety of report and data transfer formats.

In addition there may be sections of the report that a user may click on to link to information regarding specific learning objectives, the corresponding configurations, and/or state(s) resulting from the student's performance in the learning exercise. This may be useful in highlighting what the student did correctly or incorrectly. These sections that the user may click on may identified, for example, by shading certain words a particular color, underlining certain words, or by particular icons.

The system may also include a variety of security and administrative features 112 as well as other applications 113. Examples of these features include allowing the system administrator to prohibit a student from accessing the help function, viewing details of the lab before a testing situation, taking a test more than once, disabling various “mentoring” features in a testing situation, disabling certain levels of detail in the output report.

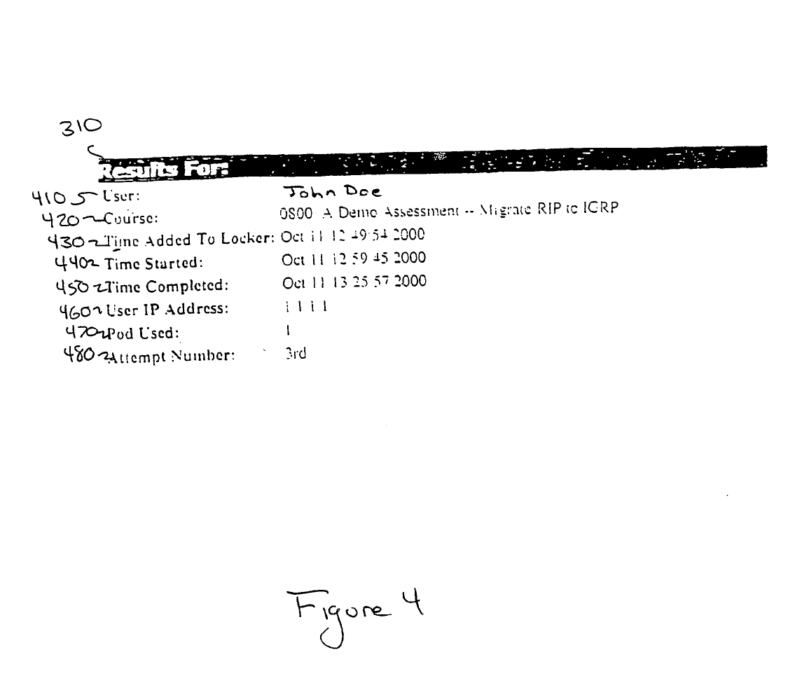

FIG. 4 provides an illustration of the Results For Report 310 that was previously discussed in reference to FIG. 3. This report may include overhead type information. For example, as illustrated this report may include the user's name 410, the title for the assignment 420, the time the assignment was purchased or selected by the user 430, the time it was started by the user 440, the time it was completed 450, the user's IP address 460, a title or identification for the pod used during the assignment 470, and the number of times the user attempted this particular assignment 480.

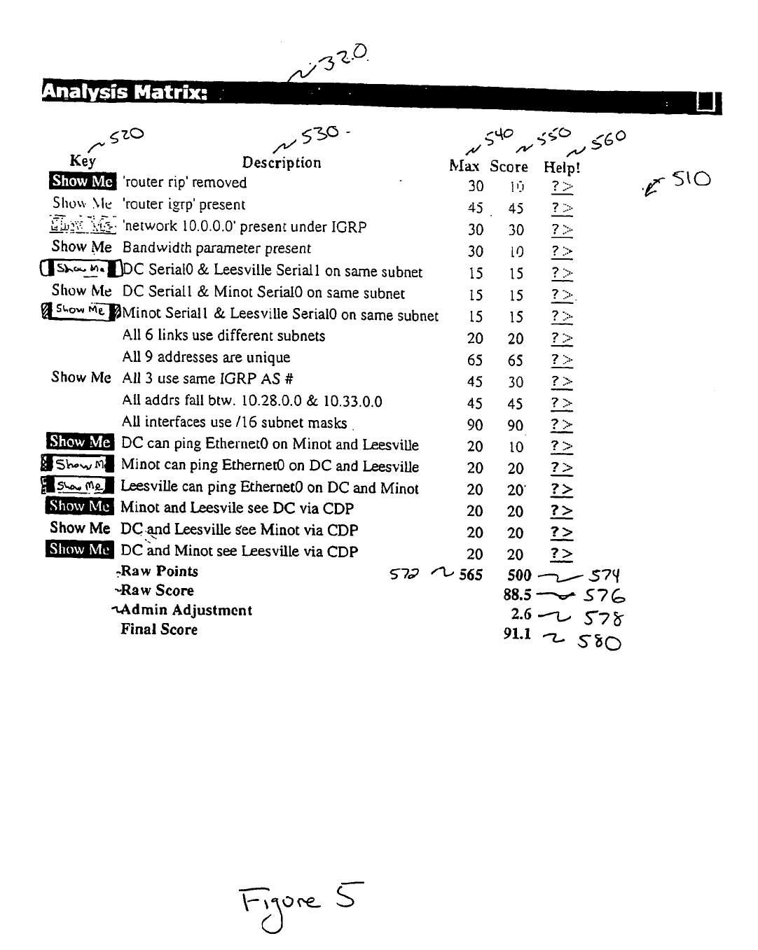

FIG. 5 illustrates an example of the Analysis Matrix 320 Report that was previously discussed in regard to FIG. 3. As illustrated, this report lists various learning objectives 510 that the user is assessed on. Each learning objective may include a key 520 that may include the words “Show Me” or a similar icon. For learning objectives where the key includes the words “Show Me,” the user may click on these words to jump to relevant sections of the configuration code created during the assignment that enable the user to see what they did right and what they did wrong during the assignment. Further, these keys (e.g., Show Me) may be color coded or shaded a particular color. This color or shading may then be used as described below in reference to the below described configuration reports and non-configuration reports.

In addition, a description 530 may be presented for each learning objective. Further, a maximum score field 540 may be listed for each learning objective may be listed. This maximum score field shows the total point that may be awarded for this learning objective if it is completed successfully. In addition, a score field 550 may be listed for each learning objective. This score field 550 lists that score that the user was awarded for the learning objective. As shown, partial credit may be awarded to a user who is not completely successful in completing the learning objective. Also, a help link 560 may be presented for each learning objective. A user may click on this help link to view additional information regarding this learning objective, such as information concerning the technical notes, reference materials, classes, other distance learning components, etc. In addition, this report may include information regarding the maximum possible raw points 572, the user's raw points 574, the user's raw score 576, any administrative adjustment 578, and the user's final score 580.

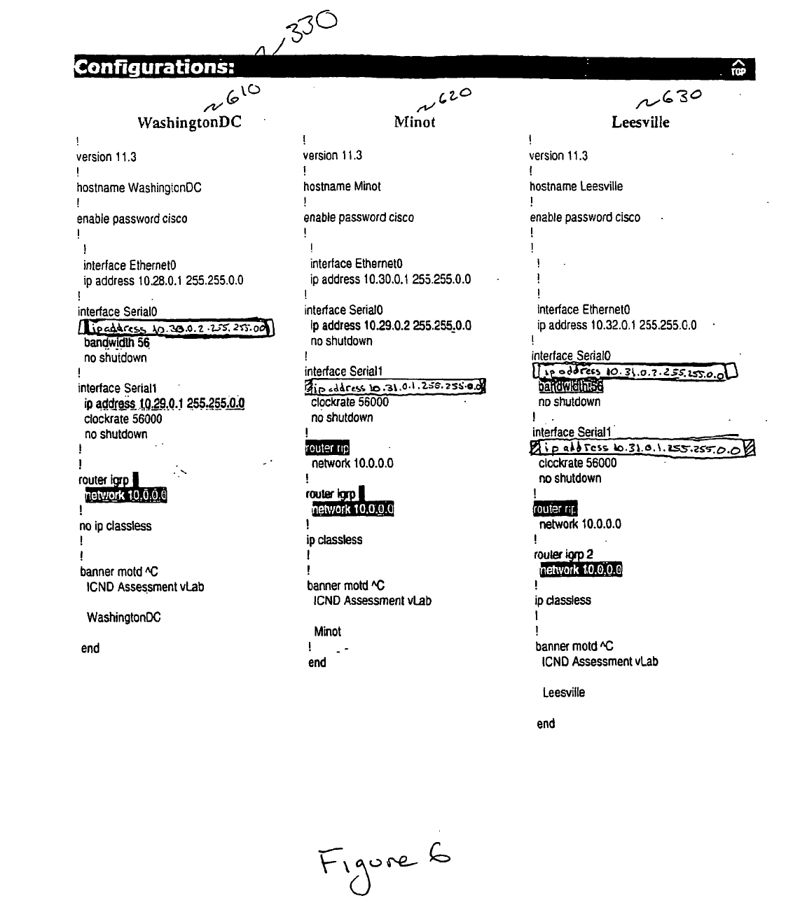

FIG. 6 illustrates an example of the Configuration Report 330 that was previously discussed in reference to FIG. 3. As discussed above, with reference to FIG. 5, a user may click on the text “Show Me” in the Analysis Matrix Report to jump to relevant sections of the configuration code. For example, by clicking on the “Show Me” text for a learning objective, the user may be presented with a Configuration Report 330 regarding the learning objective, such as illustrated in FIG. 6. Further, various information in the Configuration Report may be identified by a color or shading corresponding to the learning objective for which the “Show Me” text was selected.

As shown, the Configuration Report 330 may include information regarding each of the devices in the pod 110. In the example illustrated, these devices include a router for Washington, D.C. 610, a router for Minot 620, and a router for Leesville 630. For each of these devices, the Configuration Report may include information regarding the configuration for the device.

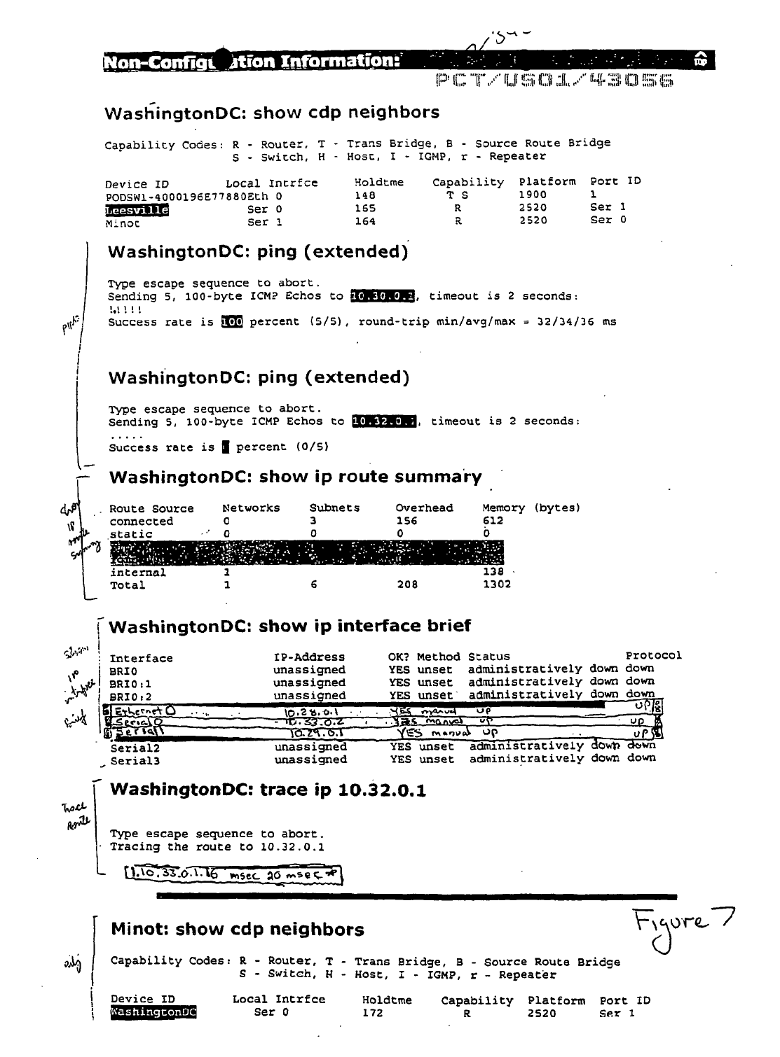

FIG. 7 illustrates an example of the Non-Configuration Report 340 that was previously discussed in reference to FIG. 3. As previously discussed, the Grader Engine 107 may execute a series of diagnostic commands that capture the actual state of the network. This therefore allows the engine to analyze real time traffic, such as ping, traceroute, adjacencies, routing tables, and other show commands. Further, as discussed above with regard to the Configuration Report 330, information in the Non-Configuration Report 340 may be identified by a particular color or shading. This shading or color preferably corresponds to the shading or color of the “Show Me” key for a particular learning objective. This helps a user to quickly identify the information in these reports that corresponds to the particular learning objective.

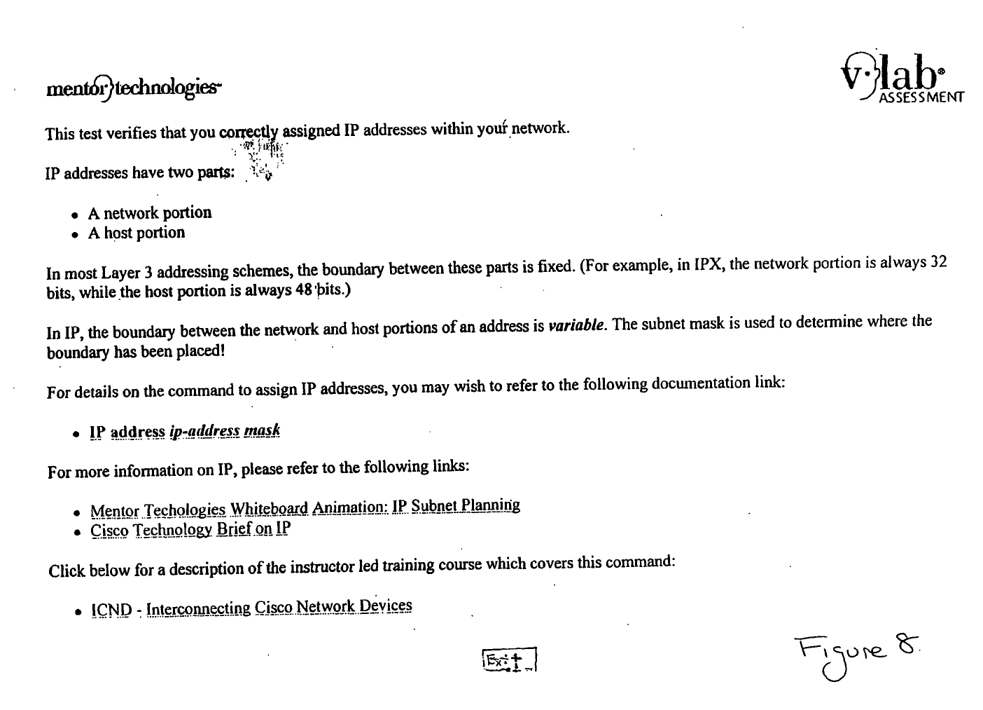

FIG. 8 illustrates an example of a screen that may be presented to a user that clicks on one of the help links 560 illustrated in FIG. 5.

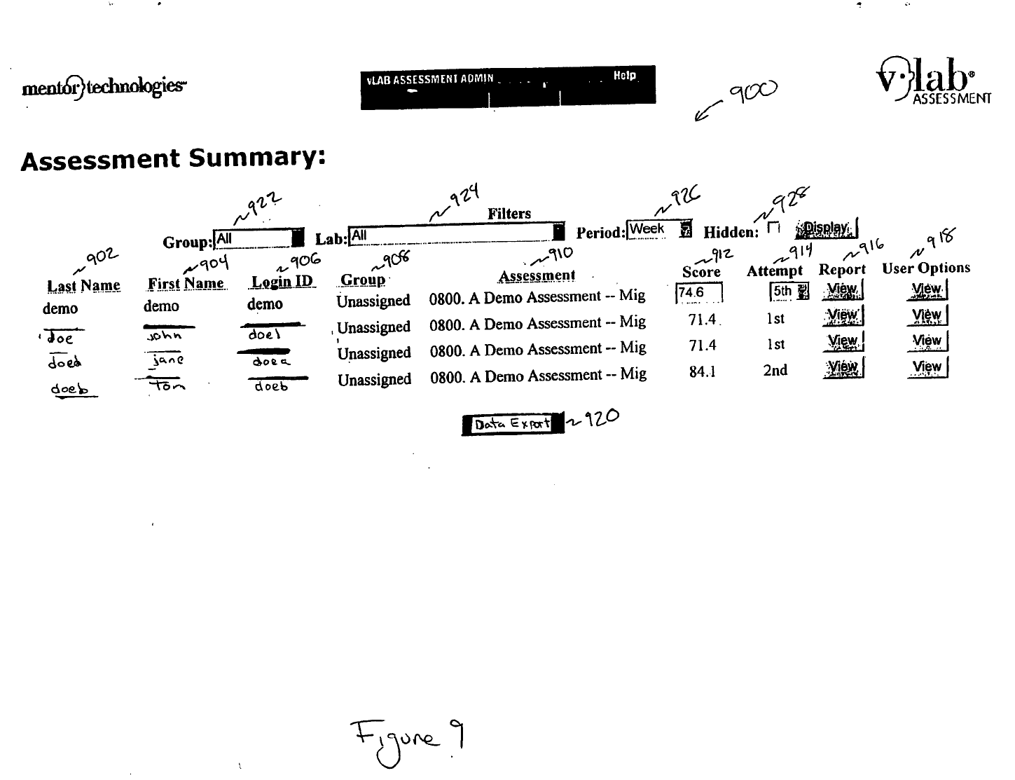

In addition to the above, the user may access a User Administration screen. FIG. 9 illustrates an example of a User Administration Screen 900 that may be presented to a user, teacher or system administrator. As shown, this screen may list the various users that performed particular assignments by last name 902, first name 904, login ID 906, and group 908. Further, this screen may list the descriptions 910 for the assignments performed, along with their score 912, and the attempt number 914 for the score. For users with more than one attempt, the score for each attempt may be listed by clicking on the attempt number and then selecting the attempt number for which the user desires to view the score. In addition, buttons may be presented that allow the user to view the report 916 and the user's options 918. Information obtained by selecting to view the user's options may include, for example, setting the administrative group the user belongs to as well as certain administrative flag that control behavior such as multiple attempts at a single exercise and removal of invalid test results.

Further, a data export button 920 may be presented to allow the data to be exported to a printer, floppy drive, some other storage device, or in a variety of formats that can be read by other systems, software packages, and databases. For example, this feature can be used to export the data to spreadsheet software. Further, scroll downs or filters, may be provided that allow a user to view the performances by individuals in a particular group 922, by the lab or assignment taken 924, the time or day during which the assignment was performed 1026. Also, a Hidden function 928 is illustrated that if selected hides or removes invalid test results from reports and export screens by default.

The above-defined methods may be performed by one or more computers or servers that is/are capable of obtaining the above described information. In addition, the above described method may be embodied in software that one or more processors in one or more computers are capable of executing

Also, although the above-described methods and systems were discussed with references to routers, they may also be used for any other type of devices, such as switches, computers, servers, PLCs, etc. Further, the above-described methods and systems also may be applied to assess a user with regard to software, such as NT, MSWord, UNIX, etc.

Appendix A presents various figures concerning an application of the above-described methods and systems as used in vLab™ systems with routers. Appendix B presents text corresponding to these figures.

While it has been illustrated and described what is at present considered to be the preferred embodiment and methods of the present invention, it will be understood by those skilled in the art that various changes and modifications may be made, and equivalents may be substituted for elements thereof without departing from the true scope of the invention.

In addition, many modifications may be made to adapt a particular element, technique or, implementation to the teachings of the present invention without departing from the central scope of the invention.

[image]

[image]

[image]

[image]

[image]

[image]

[image]

[image]

[image]

[image]

[image]

[image]

[image]

[image]

What is claimed is:

1. A method for assessing a user regarding control of one or more devices, comprising:
comparing information regarding a configuration of at least one of the devices against at least one evaluation configuration criteria;
comparing information regarding state information for the device against at least one evaluation state criteria; and
assessing the user using the above comparisons.

2. The method of claim 1, further comprising the step of obtaining information using the Simple Network Management Protocol (SNMP); and
comparing the information obtained using the Simple Network Management Protocol (SNMP) against at least one evaluation criteria, wherein the step of assessing the user includes using the comparison using the information obtained using the Simple Network Management Protocol (SNMP).

3. A method for assessing a user regarding control of one or more devices, comprising:
comparing information regarding at least one of the devices against at least one evaluation criteria;
assigning one or more weights to one or more of the evaluation criteria;
generating at least one partial credit value in regard to the comparison; and
assessing the user using the above comparisons and the one or more devices.

4. A method for assessing a user regarding control of one or more devices, comprising:
comparing information regarding at least one of the devices against at least one evaluation criteria;
generating at least one partial credit value based on the comparison; and
assessing the user using the above comparisons and the at least one partial credit value.

5. The method of claim 1, further comprising the step of:
providing a report regarding the assessment.

6. The method of claim 5, wherein the report provides one or more of the following capabilities:
linking to help information;
linking to information regarding the configuration of the one or more devices; and
linking to information regarding the states of the one or more devices.

7. The method of claim 1, further comprising
remotely accessing the one or more devices; and
exercising control over the device by the user to perform a training exercise,
wherein the user is assessed based on their performance of the training exercise.
